(19) United States
(12) Patent Application Publication
(10) Pub. No.: US 2003/0006186 A1
(43) Pub. Date: Jan. 9, 2003

(54) Spiral wound depth filter

(76) Inventors: John L. Pulek, Cheshire, CT (US); Thomas J. Hamlin, Vernon, CT (US); Richard Sale, Tolland, CT (US); C. Thomas Paul, Madison, CT (US)

Correspondence Address: CUMMINGS AND LOCKWOOD, GRANITE SQUARE, 700 STATE STREET, P O BOX 1960, NEW HAVEN, CT, 06509-1960, US

(21) Appl. No.: 10/142,561

(22) Filed: May 9, 2002

Related U.S. Application Data
(63) Continuation-in-part of application No. 09/412,419, filed on Oct. 5, 1999, now Pat. No. 6,391,200.
(60) Provisional application No. 60/103,233, filed on Oct. 5, 1998.

(51) Int. Cl. B01D 27/06

(52) U.S. Cl. 210/492; 210/497.1

(57) ABSTRACT

A spiral wound filter element is disclosed which includes at least three radially successive prequalifying sections of filter medium commencing with a radially outer prequalifying section of filter medium and concluding with a radially inner prequalifying section of filter medium, each prequalifying section of filter medium having a number of perforation formed therein, wherein the number of perforations in the filter medium of each radially successive prequalifying sections is less than the number of perforations in the filter medium of a radially preceding prequalifying section, and further including a radially inner qualifying section of filter medium succeeding the radially inner prequalifying section, the radially inner qualifying section of filter medium having imperforate filtering layers.

### CROSS-REFERENCE TO RELATED APPLICATIONS

The subject application is a continuation-in-part of U.S. patent application Ser. No. 09/412,419, filed Oct. 5, 1999, which claims priority to U.S. Provisional Patent Application Serial No. 60/103,233, filed Oct. 5, 1998, the disclosures of which is incorporated herein by reference.

### BACKGROUND OF THE INVENTION

1. Field of the Invention

The subject invention is related to fluid filtration apparatus, and more particularly, to a spiral wound depth filter having alternating layers of diffusion medium and filter medium, wherein the filter medium is provided with bypass apertures to reduce the pressure drop across he filter and increase the life of the filter.

2. Background of the Related Art

In general, a filter assembly is used for removing contaminants from liquids or gases. Such filter assemblies, for example, are used in chemical and hydrocarbon applications such as polyethylene manufacturing, food and beverage applications, electronic applications such as circuit board construction, coating applications such as high quality spray painting, and industrial applications such as paper manufacturing. Many filter assemblies include a tubular filter cartridge contained within a filter housing. The filter housing defines a sump which serves as a fluid-tight pressure vessel. Contaminated fluid is pumped into the filter housing through an inlet. The fluid passes through the cartridge and exits the filter housing through an outlet.

One type of filter cartridge is a depth cartridge defined by layers of filter medium that are spirally wrapped about a perforated core. A typical depth filter medium is a non-woven, porous, melt-blown sheet or sheets of polypropylene micro fibers. The depth filter medium can have a uniform pore structure or a graded or tapered pore structure, whereby the pore size of the depth filter medium decreases in the direction of fluid flow, i.e. from an outer to an inner diameter of the filter. The depth filter medium can also be provided with fibers of varying diameter.

Despite having a tapered or graded pore structure and/or varying fiber diameters, it has been observed that many depth filters actually act as “low area” surface filters, since only one or two of the outermost layers of filter medium become loaded with contaminants after use, while the inner layers remain relatively clean. In a depth filter cartridge that acts as a surface filter and collects contaminants in a single layer, there is an inefficient distribution of fluid over the filter medium, a higher pressure drop and lower flow rate through the filter. Such filters also tend to have a shorter useful life, and thus must be replaced often. It would be beneficial therefore to provide a filter with improved flow distribution, a lower pressure drop, high flow rate, and a longer useful life than prior art depth filters.

### SUMMARY OF THE INVENTION

The subject invention is directed to a depth filter, and more particularly to a spiral wound filter element that includes at least three radially successive prequalifying sections of filter medium commencing with a radially outer prequalifying section of filter medium and concluding with a radially inner prequalifying section of filter medium. Each prequalifying section of filter medium has a number of perforation formed therein, wherein the number of perforations in the filter medium of each radially successive prequalifying sections is less than the number of perforations in the filter medium of a radially preceding prequalifying section. The filter element further includes a radially inner qualifying section of filter medium succeeding the radially inner prequalifying section. The radially inner qualifying section of filter medium has imperforate filtering layers. In accordance with the subject invention, the filtering layers of the filter element are separated from one another by diffusion medium, and the diffusion medium is preferably defined by a bi-planar mesh material.

The subject invention is further directed to a spiral wound filter element that includes a radially outer prequalifying section having perforated filtering layers, an intermediate prequalifying section having perforated filtering layers, wherein the filtering layers of the intermediate prequalifying section have fewer perforations than the filtering layers of the radially outer prequalifying section, a radially inner prequalifying section having perforated filtering layers, wherein the filtering layers of the radially inner prequalifying section have fewer perforations than the filtering layers of the intermediate prequalifying section, and a radially inner qualifying section having imperforate filtering layers. In accordance with the subject invention, the filtering layers of the filter element are separated from one another by diffusion medium, and the diffusion medium is preferably defined by a bi-planar mesh material.

In accordance with the subject invention, the filter medium is defined by a plurality of discrete sheets of filter material, or it may be defined by a continuous sheet of filter material. It is envisioned that each sheet of filter material has a consistent pore size. Alternatively, sheets of filter material can have different pore sizes. Sheets of filter material can also have different fiber geometries.

In an embodiment of the subject invention, an outermost portion of the diffusion medium is wrapped at least once around the outermost layer of the filter element to form an outer layer of diffusion medium. It is envisioned that the radially inner qualifying section can define about between fifteen to fifty percent of the radial depth of the filter element. Preferably, however, the radially inner qualifying section defines about one-third of the radial depth of the filter element.

The subject invention is also directed to a spiral wound filter element that includes at least three radially successive prequalifying sections of filter medium commencing with a radially outer prequalifying section of filter medium and concluding with a radially inner prequalifying section of filter medium. In this embodiment of the invention, each prequalifying section of filter medium has at least one circumferential perforated filtering layer, and the number of perforations in the at least one filtering layer of each radially successive prequalifying section of filter medium is less than the number of perforations in the at least one filtering layer of a radially preceding prequalifying section. The filter element further includes a radially inner qualifying section of filter medium succeeding the radially inner prequalifying section, and the radially inner qualifying section of filter medium has imperforate filtering layers.

It is envisioned that there are about between one and ten prequalifying sections of filter medium between the radially outer prequalifying section of filter medium and the radially inner prequalifying section of filter medium of this filter element. It is also envisioned that each prequalifying section of filter medium is defined by a single circumferential perforated filtering layer.

These and other aspects of the subject invention will become more readily apparent to those having ordinary skill in the art from the following detailed description of the invention taken in conjunction with the drawings described hereinbelow.

### BRIEF DESCRIPTION OF THE DRAWINGS

So that those having ordinary skill in the art to which the subject invention appertains will more readily understand how to make and use the spiral wound filter disclosed herein, reference mat be had to the drawings wherein:

FIG. 1 is a perspective view of a spiral wound depth filter cartridge constructed in accordance with a preferred embodiment of the subject invention;

FIG. 2 is a enlarged sectional view of the spiral wound depth filter cartridge of the subject invention taken along line 2-2 of FIG. 1;

FIG. 3 is a perspective view of a portion of a diffusion layer and an adjacent prequalifying filter layer of the filter cartridge of FIG. 1;

FIG. 4 is a cross-sectional view of the diffusion layer and the prequalifying filter layer taken along line 4-4 of FIG. 3;

FIG. 5 is a cross-sectional view of the diffusion layer and the prequalifying filter layer taken along line 5-5 of FIG. 3;

FIG. 6 is a cross-sectional view, similar to FIG. 4, illustrating a diffusion layer and an alternate filter layer;

FIG. 7 is a top plan view of a depth filter constructed in accordance with a preferred embodiment of the subject invention in an unwound state with a continuous sheet of non-filtering diffusion medium and plural discrete sheets of filter media arranged thereon, the lateral edges of which overlap one another;

FIG. 8 is a perspective view of a depth filter constructed in accordance with a preferred embodiment of the subject invention in an unwound state with a continuous sheet of non-filtering diffusion medium and plural discrete sheets of filter media, the lateral edges of which abut one another;

FIG. 9 is a cross-sectional view of a filter cartridge constructed in accordance with a preferred embodiment of the subject invention, similar to FIG. 2, wherein the perforations in the filter media layers are radially aligned so as to form continuous bypass apertures;

FIG. 10 is a perspective view of another depth filter cartridge constructed in accordance with a preferred embodiment of the subject invention in an unwound state which includes a plurality of spaced apart strips of filter media arranged longitudinally along the length of a continuous sheet of diffusion medium;

FIG. 11 is a perspective view, in partial cross-section, of another spiral wound depth filter cartridge constructed in accordance with a preferred embodiment of the subject invention with plural concentric filtering sections, including a radially outer prequalifying section having perforated filtering layers, an intermediate prequalifying section having perforated filtering layers, an inner prequalifying section having perforated filtering layers, and a radially inner qualifying section having imperforate filtering layers;

FIG. 12 is a top plan view of another depth filter cartridge constructed in accordance with a preferred embodiment of the subject invention, in an unwrapped state, which includes a plurality of discrete sheets of perforated filter medium arranged along the length of a continues sheet of diffusion medium, wherein each perforated sheet has a different number of perforations formed therein;

FIG. 13 is a top plan view of yet another depth filter cartridge constructed in accordance with a preferred embodiment of the subject invention, in an unwrapped state, which includes a continuous sheet of filter medium arranged along the length of a continuous sheet of diffusion medium, wherein the sheet of filter medium is separated into plural perforated zones, wherein each zone has a different number of perforations formed therein; and

FIGS. 13a through 13d are top plan views of different areas of the filter medium shown in FIGS. 12 and 13, illustrating the relative number or absence of perforations therein.

### DETAILED DESCRIPTION OF THE PREFERRED EMBODIMENTS

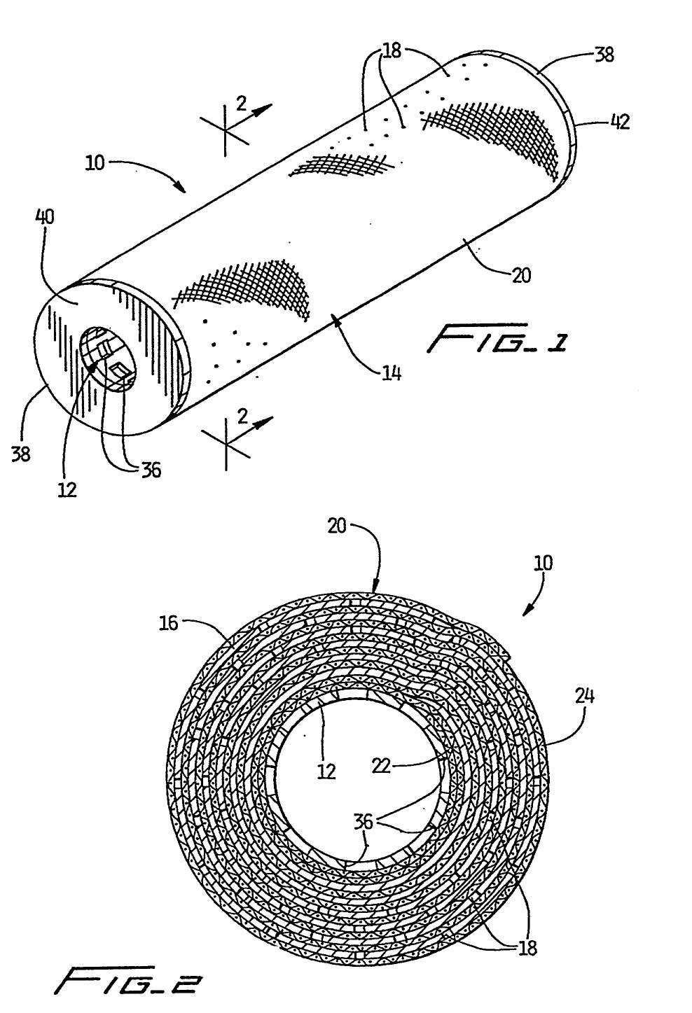

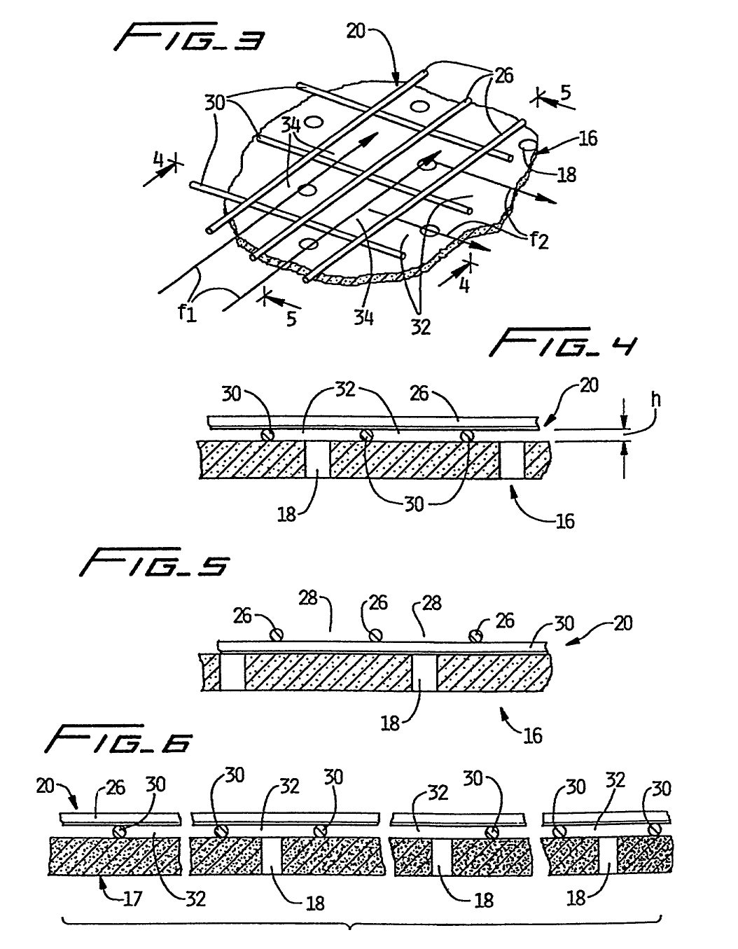

Referring now to the drawings wherein like reference numerals identify similar structural aspects of the various embodiments of the subject invention, there is illustrated in FIGS. 1 through 5 a spiral wound depth filter cartridge 10 constructed in accordance with the present disclosure. Filter cartridge 10 includes an elongated, rigid cylindrical core 12 having a multiplicity of openings 36 to facilitate the flow of fluid through the filter, and an elongated, hollow cylindrical filter element 14 coaxially disposed about the core 12. Annular end caps 38 are bonded to the opposed ends of the filter to prevent contaminated fluid from by-passing the filter 14. The configuration or type of end cap utilized can vary depending upon the filtration application and/or housing in which the depth filter cartridge 10 is employed.

The filter 14 includes at least one sheet of filter medium or media 16, with at least a portion of the filter medium 16 including bypass apertures 18, and a sheet of non-filtering diffusion medium 20. The sheets of the filter medium 16 and the diffusion medium 20 are successively wrapped, or coiled, to form alternating layers of filter medium and diffusion medium extending from an innermost layer 22 to an outermost layer 24 of the filter 14. In a preferred embodiment, the diffusion medium 20 is bonded to itself at the outermost layer 24 to prevent the filter 14 from unwinding or unwrapping during shipping, handling and use. As such, the diffusion medium 14 defines the outermost layer 24 of the filter 14.

1. The Diffusion Medium

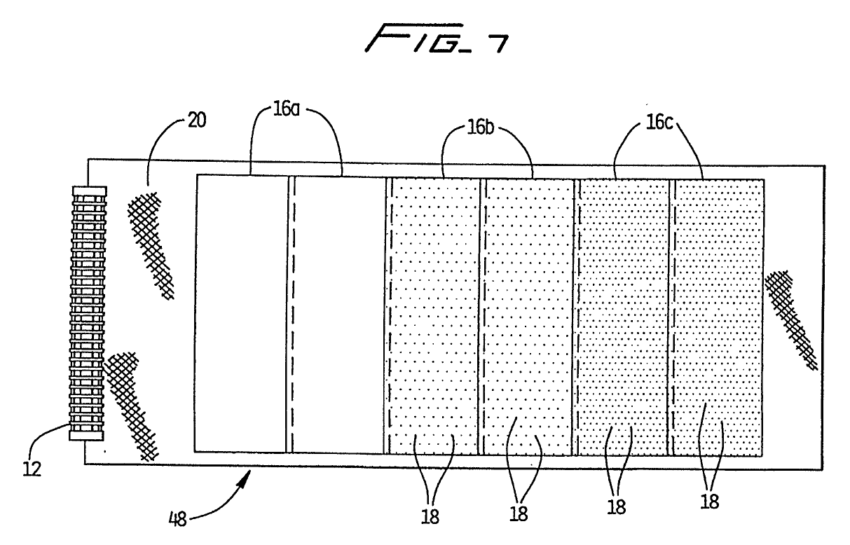

The diffusion medium 20 is a bi-planar material that includes a first plane of spaced-apart parallel strands 26 forming longitudinal passages 28, and a second plane of spaced-apart parallel strands 30 forming longitudinal passages 32, as illustrated by arrows f1, f2 in FIG. 3. The strands 30 of the second plane are oriented such that they are not parallel with the strands 26 of the first plane, such that the first and the second planes form lateral openings 34. In a preferred embodiment, strands 26 are substantially perpendicular to strands 30. The longitudinal passages 28, 32 are preferably smaller in at least one dimension as compared to the smallest dimension of the lateral openings 34. In particular, a height h of the longitudinal passages 28, 32, as best shown in FIG. 4, is preferably smaller than the length or width of the lateral openings 34.

The longitudinal passages 28, 32 of the diffusion medium 20 distribute the fluid to be filtered through flow channels f1, f2, such that the diffusion medium 20 allows for, and assists in, the longitudinal, or circumferential and/or axial, flow of the contaminated fluid within the filter 14 between the innermost layer of the filter medium 16 and the core 12, and/or between adjacent layers of the filter medium. Such longitudinal flow assists in minimizing the pressure drop across the filter cartridge 10 and in dispersing the filtration function. The diffusion medium 20 is preferably positioned between the core 12 and the innermost layer of the filter medium 16 to facilitate the passage of fluid through the openings 36 in the core 12. In a preferred embodiment, the core 12 is surrounded by a plurality of diffusion medium 20 layers to provide a collection area for the flow prior to exiting through openings in the core 12. Positioning of the diffusion medium 20 between adjacent layers of the filter medium 16 similarly maximizes the use of the filter medium surface area within each layer for contaminant loading, thereby reducing pressure drop and optimizing filter medium usage to extend filter life.

In preferred embodiments, the dimensions of the lateral openings 34 and the longitudinal passages 28, 32 of the diffusion medium 20 are purposely selected to be substantially larger than any contaminant to be filtered from the contaminated fluid. As a result, the diffusion medium 20 does not act as a filter. Since the diffusion medium 20 does not act, and is not used, as a filter to trap contaminants, the diffusion medium does not substantially contribute to the pressure drop across the filter 14, and in fact minimizes the pressure drop by providing unobstructed flow channels f1, f2 for contaminated fluid. In addition, the diffusion medium 20 provides structural rigidity and protects the filter medium 16 from damage. The filter 14 is advantageously provided with an extra outer layer of the diffusion medium 20 to add support and protection to the filter 14.

The diffusion medium 20 is made from a suitable material that is temperature and fluid compatible with the filtering application to be carried out. Preferably, the diffusion medium 20 is made of a suitable thermoplastic. For example, for lower temperature filtering applications (i.e., below 180° F.), the thermoplastic can comprise polypropylene, while for higher temperature applications (i.e., above 180° F.) or chemical compatibility with different fluids, the thermoplastic can comprise nylon, polyester, or melt-processible fluoropolymer.

The diffusion medium 20 preferably comprises thirty thousandths of an inch (30 mils) thickness, bi-planar strand orientation (17 mil strand size), twelve strands per inch, polypropylene extruded netting. Such netting is available, for example, under the trademark Plastinet®, manufactured by Applied Extrusion Technologies, Inc. of Middleton, Delaware, or Naltex®, manufactured by Nalle Plastic, Inc. of Austin, Tex. The strands 26 of the first plane may be transversely oriented with respect to the strands 30 of the second plane such that the two planes form generally square or diamond-shaped lateral openings 34 having side dimension of about 0.066 inches. Thus, a preferred diffusion medium 20 exhibits a ratio between lateral opening 34 side dimensions to lateral passage 28, 32 height (hereinafter “Side-to-Height Ratio”) of approximately 66:17 or 3.9:1. In addition, the sheet of the diffusion medium 20 is oriented so that the square lateral openings 34 form diamonds between ends 40, 42 of the cartridge 10 to advantageously distribute flow over the tubular filter.

Alternative netting dimensions may be utilized according to the present disclosure. In preferred embodiments, however, to ensure that the diffusion medium 20 does not function as a filter, the Side-to-Height Ratio should be greater than about 1.5:1 and preferably greater than 3:1. As noted hereinabove, a preferred diffusion medium 20 according to the present disclosure exhibits a Side-to-Height Ratio of about 4:1.

2. The Filter Medium

According to preferred embodiments of the present disclosure, the filter medium 16 is preferably of the depth filter type, wherein contaminants are trapped within the medium, as opposed to on an outer surface of the medium. A preferred depth filter medium 16 is comprised of one or more sheets of non-woven thermoplastic micro fibers. The non-woven thermoplastic micro fibers may be melt blown, spunbond, carded, or hydroentangled, for example. For lower temperature filtering applications (i.e., below 180° F.), the thermoplastic can comprise polypropylene, for example, while for higher temperature applications (i.e., above 180° F.) or chemical compatibility with other fluids, the thermoplastic can comprise nylon, polyester or melt-processible fluoropolymer, for example.

Furthermore, filter medium suitable for use in accordance with the present disclosure includes porous membrane, such as a cast nylon porous membrane available as Zetapore® from CUNO, Incorporated of Meriden, Conn. Other filter medium suitable for use in accordance with the present disclosure includes wet-laid paper made with such raw materials as glass or cellulose. An example of a suitable wet-laid filter medium is TSM®, available from CUNO, Incorporated of Meriden, Conn. Woven material can also be incorporated as the filter medium in accordance with the present disclosure.

The filter medium 16 is preferably provided in the form of discrete sheets, of media as opposed to being melt blown directly onto the diffusion medium. The use of discrete sheets of depth filter medium 16 has been found to simplify quality control inspection of the filter medium and make the physical properties of each filter cartridge 10 more consistent. The ability to control the consistency of the physical properties of the depth filter medium 16 provides a unique ability to achieve sharp, well-defined, and optimized control over the removal efficiency and dirt capacity of the resulting filter cartridge 10. It should be understood, however, that a filter in accordance with the present disclosure could be provided with a single continuous sheet of filter medium having plural zones of varying filtration characteristics.

According to preferred embodiments of the present disclosure, the porosity of the filter medium 16 may be constant between the inner and the outermost layers 22, 24 of the filter 14. Alternatively, a filter medium 16 can be provided having a porosity that varies between the outermost layer 24 and the innermost layer 22 of the filter, e.g., a filter having a tapered or graded pore structure. If, as preferred, the filter medium 16 comprises melt-blown, non woven polypropylene micro fibers, the pore size and/or fiber diameter geometries can be constant or varied between the outermost layer 24 and the innermost layer 22 of the filter.

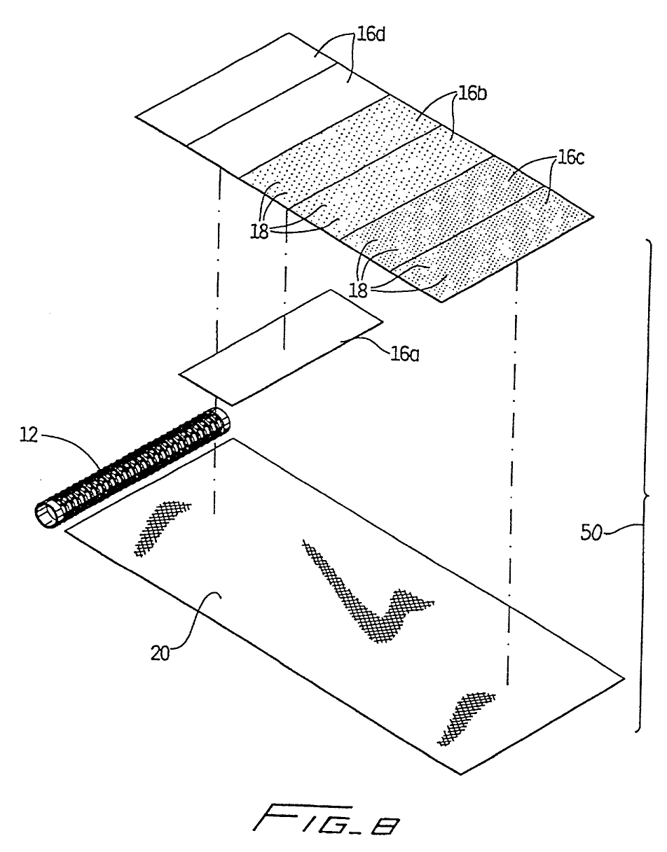

A depth filter medium 16 having a relatively uniform pore size and fiber geometry is shown for example in FIGS. 4 and 5. In contrast, a filter medium 17 having a decreasing pore size is shown in FIG. 6. The sheets of depth filter medium can also be processed, e.g., calendared or compressed, to change the porosity thereof in instances where it is desired to utilize filter medium porosity to achieve a desired filtration result.

3. The Bypass Apertures

According to preferred embodiments of the present disclosure, portions or sections of the depth filter medium 16 of filter 10 include a multiplicity of spaced-apart bypass apertures 18. Preferably, the bypass apertures 18 extend from the outermost layer 24 of the depth filter medium 16, for a distance equal to about between fifty and eighty-five percent (50%-85%) of the overall radial distance from the outermost layer 24 to the innermost layer 22 of the filter 14. Most preferably, the bypass apertures 18 extend to about sixty-six percent (66%), i.e., two-thirds, of the radial distance from the outermost layer 24 to the innermost layer 22 of the filter 14. In other words, about one-third of the radial depth of the filter element 14 does not have bypass apertures provided therein.

According to the preferred embodiments, the layers of the filter medium 16 closest to the core 12 (the radially innermost layers) do not include bypass apertures such that all of the fluid must pass through the inner layers. In this way, the innermost layers of the filter medium 16 act as qualifying layers for the filter 14. Consequently, the filter 14 can be rated based upon the particle retention characteristics of the qualifying layers. In like manner, the radially outer layers of filter medium 16 which have the bypass apertures 18 act as pre-qualifying layers.

It should be noted, however, that if the filter cartridge 10 is to be used within a filter assembly wherein contaminated fluid is forced to flow radially outwardly therethrough, i.e., the orientation of the fluid flow through the filter cartridge 10 is to be reversed relative to the embodiments described heretofore, then the bypass apertures 18 may be advantageously provided to extend from the innermost layer of the depth filter medium 16 to a radial distance of about fifty to about eighty-five percent (50%-85%) of the overall radial distance between the innermost layer 22 and the outermost layer 24 of the filter 14. When so oriented, the inner layers of the filter medium 16 will act as pre-qualifying layers, while the outer layers act as the qualifying layers.

It should also be noted that a filter according to the present disclosure is not limited to the coiled designs shown in the attached figures. The unique elements of the present disclosure, i.e., alternating layers of filter and diffusion mediums as disclosed and claimed herein, can be utilized in other filter structures, such as a pleated filter cartridge or a filter bag.

The bypass apertures 18 formed in the pre-qualifying layers of filter media 16 may be uniformly spaced-apart in predetermined patterns, and provided as generally circular openings. The geometry and relative sizes of the apertures 18, however, may be advantageously varied, e.g., circular holes and elongated slots of varying sizes are contemplated, and combinations thereof may be used. The apertures 18 may also be provided as slits, cuts or perforations in the filter medium 16, and such slits, cuts or perforations may be designed such that they do not fully open until a predetermined pressure differential is created across the filter cartridge 10. In addition, the multiplicity of bypass apertures may be provided in a number of different patterns, e.g., linearly aligned, diagonally aligned, or randomly spaced, and the pattern(s) may vary from layer to layer of the filter medium 16.

During operation, wherein filter cartridge 10 is configured for radially inward fluid flow, contaminated liquid or gas passes laterally (i.e., radially) inwardly through the lateral openings 34 in the outermost layer(s) of the diffusion medium 20. The contaminated liquid or gas then contacts an outermost layer of the filter medium 16. Contaminated liquid or gas that does not immediately pass through the outermost layer of the filter medium 16 or the bypass apertures 18 in the filter medium may be directed longitudinally, or substantially parallel with respect to the outermost layer of the filter medium 16, through the longitudinal passages 28, 32 of the diffusion medium 20, depending on the relative resistance to flow.

For each of the non-qualifying layers of filter medium 16, the bypass apertures 18 allow a portion of the fluid to pass therethrough instead of passing through the filter medium of that particular layer. After passing through one of the non-qualifying layers of filter medium, the fluid passing through the bypass apertures 18 and the fluid passing through the filter medium 16 are re-mixed and diffused in the diffusion medium 20 before being filtered by the next layer of filter medium 16. The bypass apertures 18, accordingly, help utilize all available filter medium 16 and help to reduce the pressure drop through the filter 14. Preferably, the bypass apertures 18 provide uniform contamination loading of the non-qualifying layers of filter medium 16.

4. Filter Performance

The combination of the filter medium 16, the diffusion medium 20 and the bypass apertures 18 in the manner described hereinabove has been found to have the synergistic effect of simultaneously increasing filtration capacity and minimizing pressure drop across the filter cartridge 10, without reducing the retention or removal rating of the filter. This synergistic effect is demonstrated by the following test results:

Test Cartridge No. 1

A filter cartridge utilizing non-filtering diffusion medium along with filter medium, but without bypass apertures, exhibits a filter life about two times greater than a “control” filter cartridge having neither non-filtering diffusion medium nor bypass apertures.

Test Cartridge No. 2

A filter cartridge utilizing bypass apertures along with filter medium, but without diffusion medium as described herein, does not exhibit a greater filter life than the control filter cartridge.

Test Cartridge No. 3

A filter cartridge 10 according to the present disclosure utilizing non-filtering diffusion medium 20 having a Side-to-Height Ratio of about 4:1 and relatively uniform bypass apertures 18 extending about two-thirds of the radial distance from the outermost layer to the innermost layer, exhibited three to four times the filter life of the control filter cartridge.

Test Cartridge No. 4

A filter cartridge 10 according to the present disclosure utilizing both the non-filtering diffusion medium 20 and bypass apertures 18 as described for Test Cartridge 3, and wherein the number of bypass apertures 18 increases towards the outer diameter of the filter 14, exhibits from four to five times the filter life of a control filter cartridge.

Test Cartridge 4 exhibits from two and a half to three times the filter life of a filter cartridge utilizing both non-filtering diffusion medium and bypass apertures, wherein the number of bypass apertures increases towards the outer diameter of the filter, and wherein the diffusion medium comprises a polyolefin spunbond web available as POWERLOFT® media from Kimberly-Clark Corporation of Roswell, Ga.

The advantageous performance described above for Test Cartridges 3 and 4 is confirmed by visual inspection. Upon dissection of the Test Cartridge 3 after testing, the filter medium 16 displayed contaminant loading to a radial depth from the outermost layer 24 of about fifty percent (50%) of the filter 14. In comparison, only the outermost layer of filter medium displayed contaminant loading in Test Cartridge 1. Thus, the combination of the diffusion medium 20 and the bypass apertures 18 as described for Test Cartridges 3 and 4 provides a synergetic effect that was not to be expected based upon the performances of Test Cartridges 1 and 2 possessing either non-filtering diffusion medium or bypass apertures, respectively, but not both.

The testing procedure included a single pass test at a flow rate of three gallons per minute of water containing between about 0.39 to about 1.0 grams per gallon of contaminant. Two standard contaminants were used: 0-30 micron contaminant (ISO COARSE, A.T.D. 12103-1, A4, available from Powder Technologies, Inc. of Burnsville, Minn.) and 0-10 micron contaminant (A.T.D. nominal 0-10 microns, also available from Powder Technologies, Inc). All of the filter cartridges tested had an outer diameter of about 2.5 inches and were about 10 inches long. The life of a filter for purposes of the tests is defined as the amount of contaminant challenged for the pressure drop across the filter to increase by 20 psid due to contaminant loading in the tested filter.

5. Exemplary Filter Configurations

Additional exemplary filters made in accordance with the present disclosure are described hereinbelow. However, these exemplary filters are merely illustrative of filters that may be made according to the present teachings, and are not intended to be limiting thereof.

### EXAMPLE I

Referring to FIG. 7, an exemplary filter 48 according to the present disclosure is shown. The filter 48 includes a single continuous sheet of diffusion medium 20 comprising thirty thousandths of an inch (30 mils), bi-planar strand orientation (17 mil strand size), twelve strands per inch, polypropylene extruded netting. The Side-to-Height Ratio of such diffusion medium is approximately 4:1. The filter material, which comprises melt-blown, non woven polypropylene micro fibers, is provided in a plurality of discrete sheets 16a, 16b, 16c. The plurality of sheets of filter medium 16a, 16b, 16c exhibit substantially equal and consistent pore size and fiber geometries. As shown, the ends of the sheets 16a, 16b, 16c are overlapped. The overlapping ends of the sheets 16a, 16b, 16c, however, are not sealed or bonded since the tightly wound sheet of the diffusion material 20 provides an adequate seal between the overlapping ends of filter medium.

Inner (with respect to the core 12) sheets 16a of the depth filter material do not have bypass apertures, while outer sheets 16b, 16c of the filter material have bypass apertures 18 (it should be noted that only the ends of the non-perforated qualifying layers 16a need to be overlapped). The outermost sheets 16c of filter material are preferably provided with more numerous bypass apertures 18 than the intermediate sheets 16b.

The bypass apertures 18 in sheets 16b, 16c are formed by perforating the sheets 16b, 16c prior to winding or coiling the sheets of diffusion medium 20 and filter medium 16a, 16b, 16c. In particular, sheets 16b are provided with circular perforations having diameters of about 5/32 inches, which are arranged in straight rows at intervals of about 1.2 inches, and wherein the rows are aligned and spaced at intervals of about 1.2 inch. Sheets 16c are provided with circular perforations having diameters of about 5/32 inches, which are arranged in straight rows at intervals of about 1.2 inches, and wherein the rows are staggered and spaced at intervals of about 0.6 inches. In sum, sheets 16c contain almost twice as many perforations 18 as do sheets 16b. In general, it has been found that for a 2 to 2.5 inch outer diameter filter, rated between about 2 and about 70 microns, the apertures 18 should consume about 2.5 percent of the area of each of sheets 16c, and should consume about 1.25 percent of the area of each of sheets 16b.

A first end of the sheet of the diffusion medium 20 is secured to the core 12, using heat bonding for example, and the sheet is wound about the core to create a first or innermost layer of the diffusion medium. The sheet of diffusion medium 20 and the sheets of filter medium 16a, 16b, 16c are then coiled together about the innermost layer. The sheet of the diffusion medium 20 is longer than the sheets of the filter medium 16a, 16b, 16c such that the sheet of diffusion medium will form an outermost layer around the filter medium. The outermost layer of the diffusion medium 20 is then secured to the adjacent layer of diffusion medium, using heat bonding for example, such that the filter is tightly and securely wound. Surprisingly, it has been found that winding the layers tightly does not affect either the removal efficiency or the dirt capacity of the filter 48.

### EXAMPLE II

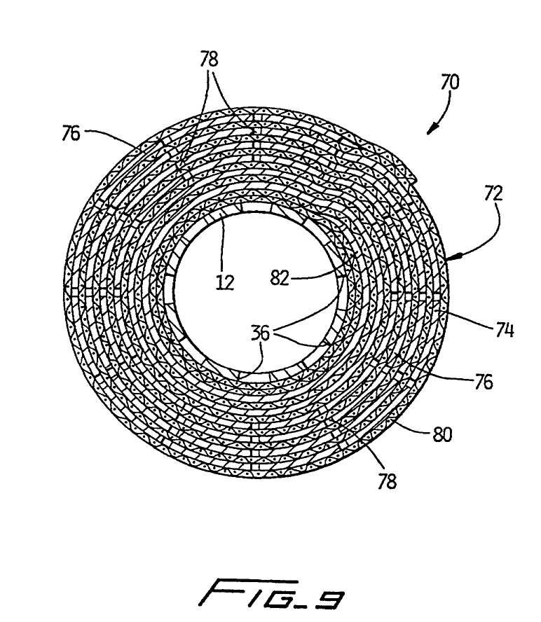

Referring to FIG. 8, a second example of a filter 50 according to the present disclosure is shown. The filter 50 includes a single continuous sheet of diffusion medium 20 comprising thirty thousandths of an inch (30 mils), bi-planar strand orientation (17 mil strand size), twelve strands per inch, polypropylene extruded netting. The Side-to-Height Ratio of the diffusion medium 20 is approximately 4:1. The filter material, which comprises melt-blown, non woven polypropylene micro fibers, is provided in a plurality of discrete sheets 16a, 16b, 16c, 16d.

The sheets of filter medium 16a, 16b, 16c exhibit substantially equal and consistent pore size and fiber geometry. Sheet 16a does not have bypass apertures, while outer sheets 16b, 16c have bypass apertures 18. The outermost sheet 16c of filter material is preferably provided with more numerous bypass apertures 18 than the intermediate sheets 16b. Most preferably, the sheets 16b, 16c are perforated in a manner substantially similar to the corresponding sheets of FIG. 7.

Sheets 16d comprise melt-blown, non woven polypropylene micro fibers that are calendared, i.e., compressed between two rollers. Prior to being calendared, sheets 16d have an substantially identical fiber geometries to the fiber geometries of sheets 16a, 16b, 16c. In the calendering process, to the extent the dimensions of the fibers are affected, the fibers assume a greater dimension in the plane of the sheet 16d. As a result, after being calendared, the sheets 16d have a reduced pore diameter as compared to sheets 16a, 16b, 16c.

As shown, prior to the filter 50 being coiled, sheet 16a is placed under sheet 16d adjacent sheet 16b. After being coiled, the filter 50 includes: 1) inner layers of filter medium (innermost sheet 16d) having a reduced pore size, 2) intermediate layers of filter medium (laid over sheets 16a and 16d) that have a pore size that alternates between a relatively smaller and larger size, and 3) outer layers of filter medium (sheets 16b and 16c) that have a relatively larger pore size.

### EXAMPLE III

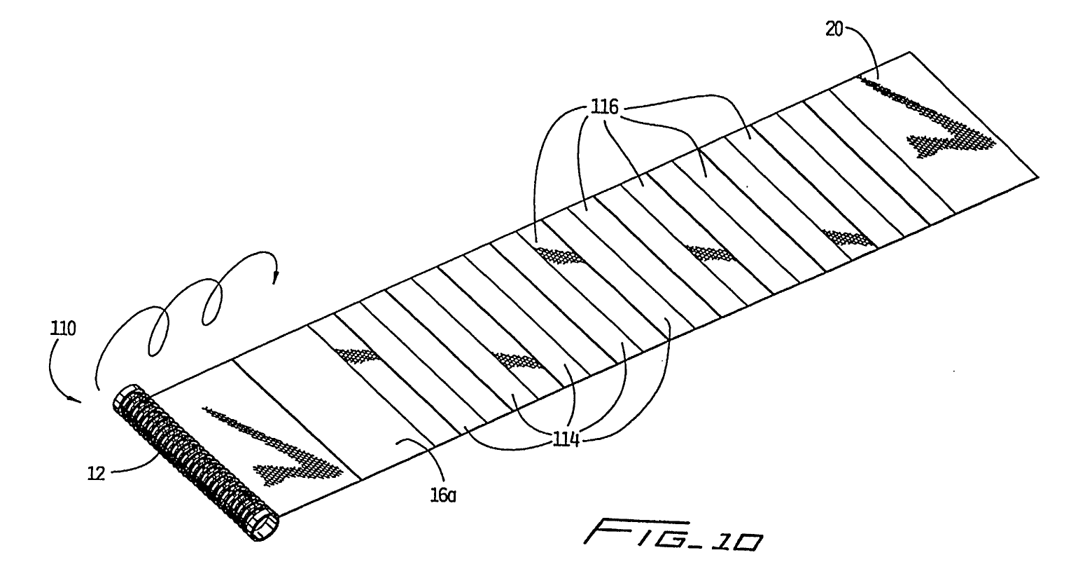

Referring to FIG. 9, another filter cartridge 70 according to the present disclosure is shown. The filter cartridge 70 is similar to the filter cartridge 10 of FIG. 7, and elements that are the same have the same reference numerals. The filter cartridge 70 includes a filter 72 having alternating layers of filter medium 74 and diffusion medium 76.

The filter medium 74 has bypass apertures formed from bores 78 extending from an outermost layer 80 towards an innermost layer 82 of the filter. The continuous bores 78 each extend to a uniform depth within the filter 72. Preferably, the bores 78 extend continuously to between about fifty and eighty-five percent (50%-85%) of the radial distance from the outermost layer 80 to the innermost layer 82 of the filter 72. More preferably, each of the bypass bores 78 extends continuously to about sixty-six percent (66%) of such radial distance. It should be noted that the filter medium of the filter cartridge 70 can be provided with bypass apertures formed by bores continuously extending from an outermost layer 80 towards an innermost layer 82 of the filter, but to non-uniform depths within the filter 72.

A method for manufacturing the cartridge 70 generally includes winding or coiling the sheet of the diffusion medium 76 and the sheet(s) of the filter medium 74 into alternating layers extending between the innermost and the outermost layers 82, 80, and piercing the layers from the outermost layer towards the innermost layer to produce the multiplicity of bypass bores 78 in the filter. The bypass bores may be created by piercing the outermost layer 80 of the filter 70 with one or more elongated, narrow, sharp instruments, such as steel pins. A multiplicity of parallel steel pins, for example, are mounted on a flat base, and the filter cartridge 70 is simply pushed onto the spikes and pierced to create the bypass bores.

### EXAMPLE IV

Referring to FIG. 10, a further filter cartridge 110 according to the present disclosure is shown (filter cartridge 110 is not shown with end caps; as will be readily apparent to persons of skill in the art). The filter cartridge 110 is similar to the filter cartridge 70 of FIG. 7, and elements that are the same have the same reference numerals. The filter cartridge 110 includes a filter having a single continuous sheet of diffusion medium 20 and at least one sheet of filter medium 16a wound around a core 12. The filter 110 also includes strips of filter medium 114 wound within the sheet of diffusion medium 20 between the sheet of filter medium 14 and the outer diameter of the filter. The strips 114 are spaced apart to create gaps that comprise bypass apertures 116.

As shown, the strips of filter medium 114 are arranged longitudinally with respect to the core 12, but the strips can be oriented in other directions, such as diagonally with respect to the core. The strips 114 are equally spaced apart from one another such that the resulting bypass gaps 116 are of substantially equal size. Alternatively, the strips can be spaced such that the resulting bypass gaps become larger towards the outer diameter of the respective filters, for example. It has been found that a filter cartridge 110 of the type disclosed in FIG. 10 provides about the same improved performance as provided by the filter cartridge 10 disclosed in FIG. 7.

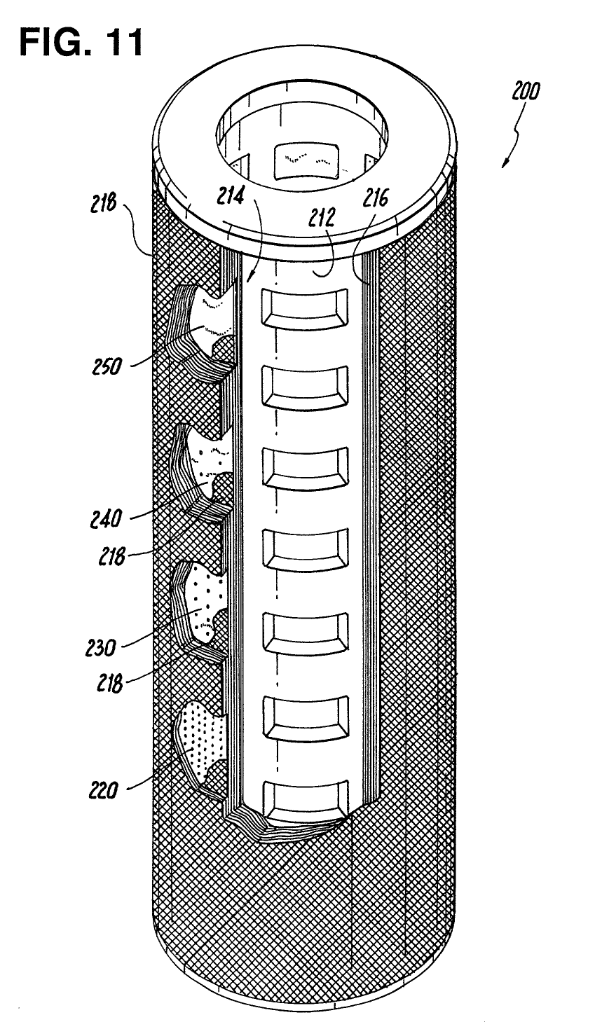

Referring now to FIG. 11, there is illustrated another spiral wound depth filter cartridge constructed in accordance with a preferred embodiment of the subject invention and designated generally by reference numeral 200. Filter cartridge 200 is similar to the depth filters described hereinabove in that it includes a cylindrical filter element 214 formed by alternating successively wound layers of filter media 216 and diffusion media 218 wrapped about a perforated cylindrical core 212. Filter cartridge 200 differs from those described above in that it contains a greater number of prequalifying sections or perforated filtration zones.

More particularly, and by way of example, filter cartridge 200 has four distinct filtering sections including: 1) a radially outer prequalifying section 220 having perforated filtering layers; 2) an intermediate prequalifying section 230 having perforated filtering layers; 3) an inner prequalifying section 240 having perforated filtering layers; and 4) a radially inner qualifying section 250 having imperforate filtering layers. While this example of filter cartridge 200 has only one intermediate prequalifying layer, it is envisioned and well within the scope of the subject disclosure that there may be plural intermediate prequalifying sections disposed between the outer prequalifying section 220 and the inner prequalifying section 240.

In accordance with the subject disclosure, the filter media which defines the filter layers of each prequalifying section 220, 230 and 240 of filter cartridge 200 is perforated. In other words, there are bypass apertures, that are preferably circular in configuration, formed in the filter media. Of course, as discussed previously, the size and shape of the apertures can vary.

In accordance with the subject invention, the number of perforations in each radially successive prequalifying section 220, 230, and 240 is different. More particularly, there is a greater number of perforations formed in the filter media of the outer prequalifying section 220 that in the intermediate prequalifying section 230. Likewise, the perforations formed in the filter media of the inner prequalifying section 240 are fewer in number than in the intermediate prequalifying section 230. In other words, the number of perforations or by-pass apertures decreases in each radially successive prequalifying section of depth filter 200.

As illustrated in FIG. 11, the radially inner qualifying section 250 of filter 200 defines about one-third of the radial depth of the filter element 214. It is envisioned however, that the radially inner qualifying section 250 can define about between fifteen percent (15%) to fifty percent (50%) of the radial depth of the filter element.

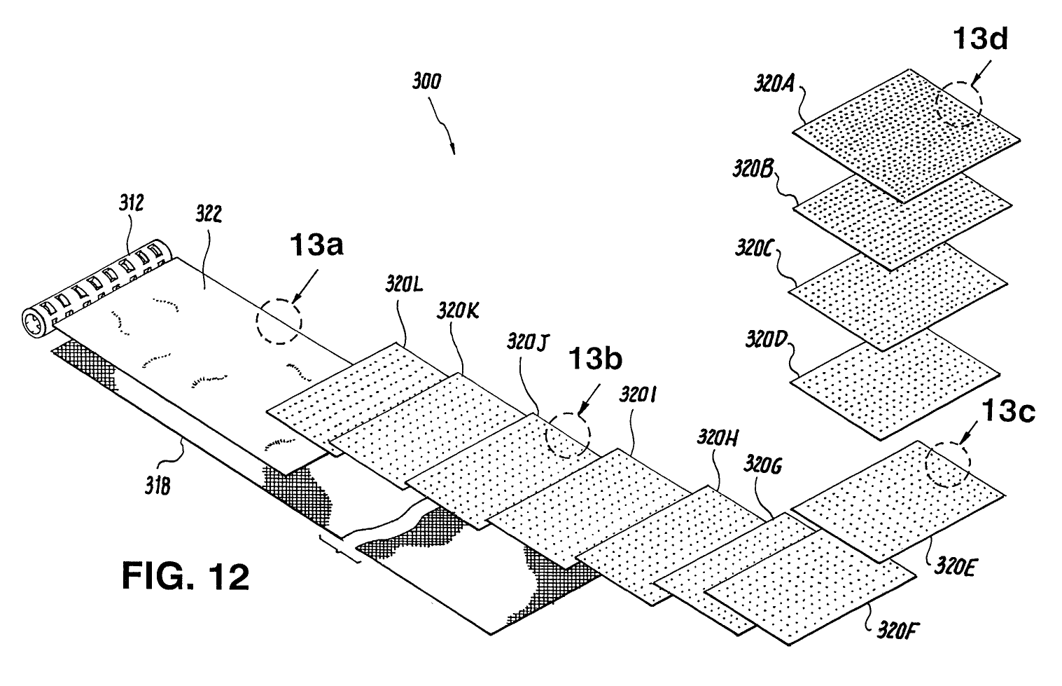

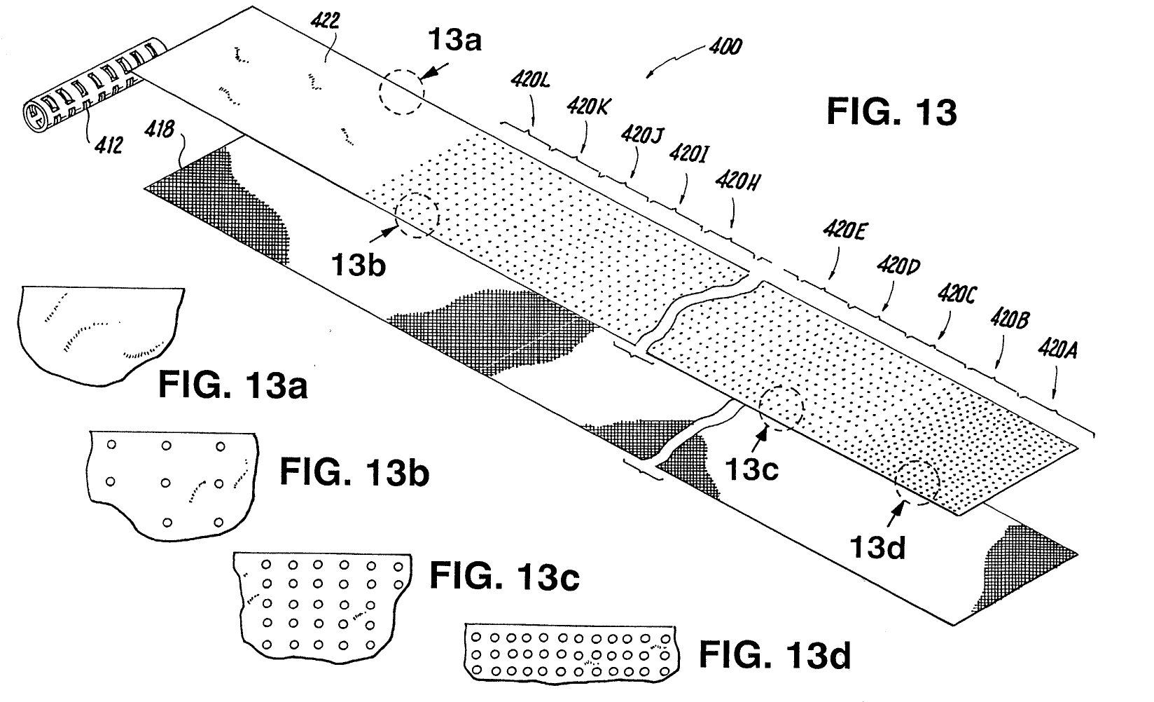

Referring now to FIG. 12, there is illustrated, in an unwrapped or unfurled condition, another spiral wound depth filter cartridge constructed in accordance with a preferred embodiment of the subject invention and designated generally by reference numeral 300. By way of example, filter cartridge 300 includes a plurality of discrete sheets of perforated filter medium. In this case there are twelve (12) sheets of perforated filter medium numbered 320A-320L, arranged along the length of a continuous sheet of diffusion medium 318 to define the prequalifying sections of filter cartridge 300. Filter cartridge 300 also includes one or more discrete sheets of imperforate filter medium 322 (see FIG. 13a) defining the radially inner qualifying section of the filter cartridge 300. As illustrated, each of the discrete sheets of perforated filter medium 320A-320L has a different number of perforations (see, for example, FIGS. 13b-13d) and is particularly dimensioned and configured so that when the filter medium and diffusion medium 318 are wrapped about the cartridge core 312, each of the twelve discrete sheets of perforated filter medium forms a distinct circumferential prequalifying layer of filter medium.

In the exemplary filter cartridge of FIG. 12, there would be twelve (12) distinct prequalifying layers, each with a different number of perforations. The outermost layer of filter media 320A has the greatest number of perforations formed therein and the innermost circumferential layer of filter media 320L has the fewest number of perforations formed therein. It is envisioned that each of the discrete sheets of filter material can have a consistent pore size or they can each have different pore sizes. It is also possible that each sheets of filter material can have different fiber geometries.

It is also envisioned that the number of circumferential layers in the filter element 300 can vary depending upon the thickness of the filter media as well as the overall allowable cartridge dimensions dictated by the cartridge housing. The maximum number of circumferential prequalifying layers would be in the range of about between six (6) and twelve (12) layers. Although, it is possible that more than twelve (12) circumferential perforated prequalifying layers could be provided for certain cartridge configurations. In any case, it is preferable that the radial depth of the radially inner qualifying layers or section defined by the imperforate filter media constitute about between fifteen percent (15%) to about fifty percent (50%) of the radial depth of the filter element, and preferably about one-third of the radial depth of the filter element.

Preferably, the diffusion medium 318 has a length that is greater than the combined length of the discrete sheets of filter media arranged thereon so that a portion of the diffusion media 318 can be wrapped at least once around the cartridge core 312 to provide an innermost layer of diffusion medium. Furthermore, the diffusion medium 318 should be long enough to wrap at least once around the outer periphery of the filter element to form an outermost layer of diffusion medium. This outermost layer of diffusion medium is preferably secured to an adjacent layer of diffusion medium by bonding, or a similar joining technique, so that the filter cartridge 300 is securely wound.

Referring now to FIG. 13, there is illustrated, in an unwrapped or unfurled state, yet another spiral wound depth filter cartridge constructed in accordance with a preferred embodiment of the subject invention and designated generally by reference numeral 400. Filter cartridge 400 is substantially similar to depth filter 300 in that it includes a plurality of successively wrapped circumferential prequalifying layers each having a different number of perforations formed therein. Depth filter 400 differs however, from depth filter 300 in that the filter media is defined by a continues sheet of material, arranged along the length of a continuos sheet of diffusion medium 418, and separated into plural filtration zones each having a different filtration characteristic.

In particular, as illustrated in FIG. 13, by way of example, there are twelve perforated prequalifying zones, of which zones 420A-420E and 420H-420L are shown, and one imperforate qualifying zone 422 defined in the continuous sheet of filter media 416. Each qualifying zone has a different number of perforations formed therein (see, for example, FIGS. 13b-13d) with the radially outer prequalifying zone 420A having the greatest number of perforations and the radially inner prequalifying zone 420L having the fewest number of perforations.

As in depth filter 300, the twelve (12) perforated zones 420A-420L are dimensioned and configured so that each zone forms a distinct circumferential prequalifying layer or section of the spiral wound filter element 400. Furthermore, as in the case of depth filter 300, the number of prequalifying zones can vary, and the radial depth of the radially inner qualifying layers or section defined by the imperforate filter medium should constitute about between fifteen percent (15%) to about fifty (50%) percent of the radial depth of the filter element, and preferably about one-third of the radial depth of the filter element.

As in the previous example, the diffusion medium 418 has a length that is greater than the combined length of the continuous sheet of filter media arranged thereon so that a portion of the diffusion media 418 can be wrapped at least once around the cartridge core 412 to provide an innermost layer of diffusion medium, and at least once around the outer periphery of the filter element to form an outermost layer of diffusion medium.

As noted previously, it is envisioned that the number of prequalifying layers in the spiral wound depth filter of the subject invention can vary depending upon the application with which the filter is employed. Table 1.0 sets forth the relationship between the number of perforations formed in the successive radial prequalifying sections or layers for filters configured in the manner illustrated and described with respect to FIGS. 11-13 which have between three (3) and nine (9) filtering sections. In each instance, the radially inner qualifying layer is defined by imperforate filter media.

TABLE 1.0

| Filtering | Prequalifying Sections | |
|---|---|---|
| Sections | (perforations per square inch of filter media) | |
| 3 | 1 | 2 |

| | | | |
|---|---|---|---|
| 4 | 0.75 | 1.5 | 2.25 |

| | | | | |
|---|---|---|---|---|
| 5 | 0.75 | 1.25 | 1.75 | 2.25 |

| | | | | | |
|---|---|---|---|---|---|
| 6 | 0.75 | 1.0 | 1.5 | 2.0 | 2.25 |

| | | | | | | |
|---|---|---|---|---|---|---|
| 7 | 0.75 | 1.0 | 1.25 | 1.75 | 2.0 | 2.25 |

| | | | | | | | | |
|---|---|---|---|---|---|---|---|---|
| 9 | 0.62 | 0.87 | 1.13 | 1.38 | 1.62 | 1.87 | 2.13 | 2.38 |

Those skilled in the art should readily appreciate that the numerical relationships sets forth in Table 1.0 are merely illustrative of the relationships or proportions that may exist between the number of perforations in radially successive media layers of the spiral wound depth filter of the subject invention.

Although the filtration apparatus and method of filtration of the subject invention has been described with respect to preferred embodiments, those skilled in the art will readily appreciate that changes and modifications may be made thereto without departing from the spirit and scope of the present invention as defined by the appended claims.

What is claimed is:

1. A spiral wound filter element comprising:
a) a radially outer prequalifying section having perforated filtering layers,
b) an intermediate prequalifying section having perforated filtering layers, wherein the filtering layers of the intermediate prequalifying section have fewer perforations than the filtering layers of the radially outer prequalifying section;
c) a radially inner prequalifying section having perforated filtering layers, wherein the filtering layers of the radially inner prequalifying section have fewer perforations than the filtering layers of the intermediate prequalifying section; and
d) a radially inner qualifying section having imperforate filtering layers.

2. A spiral wound filter element as recited in claim 1, wherein the filtering layers are separated from one another by diffusion medium.

3. A spiral wound filter element as recited in claim 2, wherein the diffusion medium is defined by a continuous sheet of bi-planar mesh material.

4. A spiral wound filter element as recited in claim 3, wherein the filtering layers and diffusion medium are wrapped about a perforated cylindrical core.

5. A spiral wound filter element as recited in claim 1, wherein the filtering layers are defined by a plurality of discrete sheets of filter medium.

6. A spiral wound filter element as recited in claim 1, wherein the filtering layers are defined by a continuous sheet of filter medium.

7. A spiral wound filter element as recited in claim 5, wherein each sheet of filter medium has a consistent pore size.

8. A spiral wound filter element as recited in claim 5, wherein sheets of filter medium have different pore sizes.

9. A spiral wound filter element as recited in claim 5, wherein sheets of filter medium have different fiber geometries.

10. A spiral wound filter element as recited in claim 2, wherein an outermost portion of the diffusion medium is wrapped at least once around the outermost layer of the filter element to form an outer layer of diffusion medium.

11. A spiral wound filter element as recited in claim 1, wherein the radially inner qualifying section defines about between fifteen to fifty percent of the radial depth of the filter element.

12. A spiral wound filter element as recited in claim 1, wherein the radially inner qualifying section defines about one-third of the radial depth of the filter element.

13. A spiral wound filter element comprising:
a) at least three radially successive prequalifying sections of filter medium commencing with a radially outer prequalifying section of filter medium and concluding with a radially inner prequalifying section of filter medium, each prequalifying section of filter medium having filtering layers with a number of perforation formed therein, wherein the number of perforations in the filter medium of each radially successive prequalifying sections is less than the number of perforations in the filter medium of a radially preceding prequalifying section; and
b) a radially inner qualifying section of filter medium succeeding the radially inner prequalifying section, the radially inner qualifying section of filter medium having imperforate filtering layers.

14. A spiral wound filter element as recited in claim 13, wherein the filtering layers are separated from one another by diffusion medium.

15. A spiral wound filter element as recited in claim 14, wherein the diffusion medium is defined by a continuous sheet of bi-planar mesh material.

16. A spiral wound filter element as recited in claim 14, wherein the filtering layers and diffusion medium are wrapped about a perforated cylindrical core.

17. A spiral wound filter element as recited in claim 13, wherein the filter medium is defined by a plurality of discrete sheets of filter material.

18. A spiral wound filter element as recited in claim 13, wherein the filter medium is defined by a continuous sheet of filter material.

19. A spiral wound filter element as recited in claim 14, wherein an outermost portion of the diffusion medium is wrapped at least once around the outermost layer of the filter element to form an outer layer of diffusion medium.

20. A spiral wound filter element as recited in claim 13, wherein the radially inner qualifying section defines about between fifteen to fifty percent of the radial depth of the filter element.

21. A spiral wound filter element as recited in claim 13, wherein the radially inner qualifying section defines about one-third of the radial depth of the filter element.

22. A spiral wound filter element comprising:
a) at least three radially successive prequalifying sections of filter medium commencing with a radially outer prequalifying section of filter medium and concluding with a radially inner prequalifying section of filter medium, each prequalifying section of filter medium having at least one circumferential perforated filtering layer, wherein the number of perforations in the at least one circumferential perforated filtering layer of each radially successive prequalifying section of filter medium is less than the number of perforations in the at least one circumferential perforated filtering layer of a radially preceding prequalifying section; and
b) a radially inner qualifying section of filter medium succeeding the radially inner prequalifying section, the radially inner qualifying section of filter medium having imperforate filtering layers.

23. A spiral wound filter element as recited in claim 22, wherein there are about between one and ten prequalifying sections of filter medium between the radially outer prequalifying section of filter medium and the radially inner prequalifying section of filter medium.

24. A spiral wound filter element as recited in claim 22, wherein each prequalifying section of filter medium is defined by a single circumferential perforated filtering layer.

25. A spiral wound filter element as recited in claim 22, wherein the filtering layers are separated from one another by diffusion medium.

26. A spiral wound filter element as recited in claim 25, wherein the diffusion medium is defined by a continuous sheet of bi-planar mesh material.

27. A spiral wound filter element as recited in claim 25, wherein the filtering layers and diffusion medium are wrapped about a perforated cylindrical core.

28. A spiral wound filter element as recited in claim 22, wherein the filter medium is defined by a plurality of discrete sheets of filter material.

29. A spiral wound filter element as recited in claim 28, wherein each prequalifying section of filter medium is defined by a single circumferential perforated filtering layer defined by a discrete sheet of filter material.

30. A spiral wound filter element as recited in claim 22, wherein the filter medium is defined by a continuous sheet of filter material.

31. A spiral wound filter element as recited in claim 25, wherein an outermost portion of the diffusion medium is wrapped at least once around the outermost layer of the filter element to form an outer layer of diffusion medium.

32. A spiral wound filter element as recited in claim 22, wherein the radially inner qualifying section defines about between fifteen to fifty percent of the radial depth of the filter element.

33. A spiral wound filter element as recited in claim 22, wherein the radially inner qualifying section defines about one-third of the radial depth of the filter element.
